(19) United States
(12) Patent Application Publication
(10) Pub. No.: US 2009/0136644 A1
(43) Pub. Date: May 28, 2009

(54) Multi-Layer Self-Separating Gel

(75) Inventors: Ted Anthony Russin, San Diego, CA (US); Raymond Charles Valli, San Diego, CA (US)

Correspondence Address: CP Kelco US, INC, 1000 PARKWOOD CIRCLE, SUITE 1000, ATLANTA, GA, 30339, US

(73) Assignee: CP KELCO U.S., INC., Atlanta, GA (US)

(21) Appl. No.: 11/946,406

(22) Filed: Nov. 28, 2007

(51) Int. Cl. A23L 1/035; A23L 1/48; A23L 1/09; A23L 1/275

(52) U.S. Cl. 426/572; 426/573; 426/564

(57) ABSTRACT

A multi-layer self-separating gel is described. A food composition comprising a first layer and a second layer comprises water, low acyl gellan gum, and an emulsifier. The composition can further comprise a third layer. A process of preparing a multi-layered food composition can comprise the steps of dry blending the low acyl gellan gum and the emulsifier to form a dry blend; adding the dry blend to water to form a mixture; agitating the mixture; heating the mixture to a temperature above about 54° C.; subjecting the mixture to high shear mixing at a temperature above about 54° C.; cooling the mixture to about 54° C. while continuing to mix said mixture; and ceasing the mixing of the mixture. Lack of protein in the gel minimizes its allergenicity; the gel is vegetarian; and the gel's physical properties allow for the potential of creating a shelf stable product.

### BACKGROUND OF THE INVENTION

The present invention relates to a multi-layer self-separating gel. Similar layered gels are described in the prior art. One such layered gel is a dessert gel based on a dry mix that is prepared at home and consumed shortly after preparation. (See U.S. Pat. No. 4,869,917, describing Kraft's Jell-O® 1-2-3 product). Another such gel is also a dessert gel which utilizes a proteinaceous based whipping agent combined with a gelling agent to obtain distinct layers (Dr. Oetker's Trio Treat® dessert).

The Kraft Jell-O® product is a dessert having three layers and was designed to be prepared at home. Its preparation involves mixing a dry powder with hot water, followed by addition of cold water, blending, and setting under refrigeration. The triple layer dessert produced from this mix was to be consumed shortly after preparation. The main gelling agent in this formulation is gelatin. The ingredient responsible for the separation of the second and third layer of this product is described as a maltodextrin encapsulated dry fat emulsion (See U.S. Pat. No. 4,869,917, [Column 2, Lines 30 to 37]. It is believed that this Jell-O® product is no longer commercially available.

A second, and currently commercially available dry mix product from Dr. Oetker Limited, under the brand name of Trio Treat®, produces a triple layer dessert gel, with one layer being a gel, another an intermediate semi-foam/semi-gel, and the other a foam. The product involves mixing a powder with cold water and setting under refrigeration. The main gelling agent in this product is sodium alginate, and the ingredients contributing to the intermediate and foam layers are a mixture of various fats (hydrogenated palm kernel and coconut oil), emulsifiers (acetylated monoglycerides), modified milk ingredients, and gelatin.

The main gelling agent in the Jell-O® system is gelatin, which has a relatively low setting point (˜7° C.). This low setting point of gelatin requires two significant processing steps 1) aeration of the available gelatin and emulsifiers in the formulation at lower temperatures (after addition of cold water), and 2) ample time for the aerated layers to separate and set upon refrigeration. This temperature requirement excludes the ability to use gelling products such as low acyl gellan gum, because low acyl gellan gum has a considerably higher setting temperature (˜50° C.), as such it would set at a higher temperature not allowing enough time for the aerated layers to separate. Also, the use of gelatin is not preferred in many food applications because the vegetarian market cannot be entered.

The technology used in the Trio Treat® dry mix system is very similar to that of the Jell-O® system. It produces a triple-layered water dessert gel using a combination of whipping proteins and sodium alginate, a cold water soluble gelling agent. This system requires the use of proteins, which are not always preferred ingredients, as described herein (allergenicity). Preparation of the dry mix using cold water allows for the dairy-based whipping ingredients included in the product to be whipped, aerating the liquid matrix, and allowing for subsequent layer separation based on a density gradient. The cold temperature procedure makes this formulation and process unsuitable for the use of a gelling agent such as low acyl gellan gum which requires heat for full hydration.

The current invention differs fundamentally from the Trio Treat approach because there is no protein used at all in the formulation. Further, aeration is facilitated by the use of an emulsifier blend.

The inability of the systems, described in the prior art, to produce a triple layer gel using traditional ingredients, such as low acyl gellan gum, presented a need to develop a liquid matrix that aerates at high temperatures (>50° C.) and uses a different combination of ingredients. Prior art products, including those describe above, are restrictive. The processes for producing the triple layer self-separating dessert gels are quite detailed and require close attention to the temperature of processing as well as the form and intensity of shearing to ensure optimum aeration of the matrix which facilitates the separation of the dessert gel system into layers upon cooling and setting.

The ingredients and methods of the present invention provide many advantages when compared to the prior art. One benefit is ease of preparation because the invention utilizes only a single processing stream, which saves processing time as well as minimizes processing complexity. Previous industrial approaches require that each layer be poured separately, allowed to set and then the subsequent layers poured and set. Another benefit, at least for dessert gels as one example, directly affects the consumer. The present invention results in a ready-to-eat dessert gel which is easily distributed and easily consumed by the costumer because it can be eaten immediately after purchase. Dry mixes, historically available on the market, require preparation by the end user in the home. The invention eliminates the need for preparation at home. In addition, products of the present invention have a considerably longer shelf life than home prepared dry mixes. Preliminary shelf-life studies indicate that the upper foam layer is stable for a period of between four to six weeks of refrigerated storage, a shelf-life comparable to single phase refrigerated gel cups currently on the market. The low pH of the system, combined with the use of preservatives, such as sodium benzoate, ensures that the product is safe for consumption throughout the shelf-life of four to six weeks, described above.

All of the ingredients of the present invention are currently commercially available and do not require any further modification. The fact that there is no protein used in the invention minimizes its allergenicity. The use of low acyl gellan gum instead of gelatin ensures a vegetarian gel and its physical properties allow for the potential of creating a shelf stable product, i.e., if the solution is pasteurized and filled aseptically the gel system will not melt under room temperature storage conditions as compared to gelatin gels, thus ensuring ease of use for the customer and reducing refrigeration costs for the producer.

### BRIEF DESCRIPTION OF THE INVENTION

This invention relates to layered gel systems comprising a gelling agent and an emulsifier. The gelling agent in this system is specifically low acyl gellan gum, but one skilled in the art would recognize other available gelling agents. The gelling agent may be present in an amount between about 0.01% (w/w) to about 2% (w/w), more preferably at about 0.2% (w/w). Acceptable emulsifying agents may include, but are not limited to monoglycerides, propylene glycol monoester, sodium stearoyl lactylate, calcium silicate, or combinations thereof. One skilled in the art would recognize other available emulsifying agents. The emulsifier may be present in an amount between about 0.01% (w/w) to about 5% (w/w), more preferably about 1% (w/w).

The invention might also include a buffer system, flavorant, a colorant, a sweetener, a preservative, or a combination thereof. Examples include, but are not limited to, citric acid/sodium citrate buffer systems, water and/or oil soluble flavors, natural and/or artificial food colors including oil and water soluble dispersions, pigments and lake pigments, artificial and natural sweetening agents, and natural and artificial preservatives.

A method of making the layered gels described herein includes blending the low acyl gellan gum, the emulsifier blend, sugar, buffer system and preservative to form a dry blend. The dry blend is added to water to form a liquid matrix. The liquid matrix is agitated for sufficient time and heated to a temperature of at least 85 to 90° C. to hydrate the low acyl gellan gum as well as ensure that the emulsifier blend is melted. The liquid matrix is then subjected to high shear mixing (9000-10000 RPM) using a high shear mixer, such as a laboratory scale Silverson® mixer. A high shear rate is required to minimize the particle size of the melted emulsifier blend as well as maximize the amount of aeration of the liquid matrix. This high shear can be carried out while the solution is cooled from 85 to 90° C., to ˜54° C. After the high shear mixing and cooling is stopped, a liquid system results comprising water, low acyl gellan gum, and an emulsifier, which will separate into two or three layers and eventually gel as the system's temperature drops below ˜54° C. The number of layers was experimentally shown to be a result of the amount of time the heated liquid matrix (>54° C.) is exposed to high shear. Exposure to high shear (9000-10000 RPM) for an extended period of time, i.e., two to three minutes during cooling, will result in a two layer system comprised of a clear bottom layer and an aerated foam on top, while exposure to high shear (9000-10000 RPM) for less than one minute during cooling will result in a three layer system.

One important feature of this invention lies in the fact that a gel composed of two and/or three separate and discernible layers can be created from the deposition of one single homogeneous stream. This distinguishing feature facilitates the production of layered dessert gels in an industrial setting removing the traditional processing limitations such as the mixing of dairy and non-dairy ingredients, the time required to pour and set three distinct layers, and/or the allergenicity and lifestyle issues surrounding protein containing desserts made from animal sources such as gelatin, at least for food gels. Previous art related to food gels used protein and fat containing systems to be prepared in the home kitchen. The possibility of processing and preparing these dual and/or triple layer desserts in an industrial setting opens up the potential for a new type of ready-to-eat dessert gel previously unavailable to customers.

One embodiment of the invention results in a fun and attractive triple layer dessert from a single processing stream, see Table 1. During cooling and setting the matrix separates into a ready-to-consume dessert gel composed of a very light foam layer on top, an aerated gel layer in the center, and a crystal clear water gel layer on the bottom. Informal sensory testing indicated that the three layers are, in addition to visually different, quite different in terms of texture and taste. The low viscosity of low acyl gellan gum at high temperatures is integral to the separation of the three layers during cooling. In addition, the top very light foam layer is stabilized due to the elevated setting temperature of low acyl gellan gum. That is, the low acyl gellan gum gels at elevated temperatures and sets and stabilize the foam, such that the foam does not collapse when the matrix is still warm (>40° C.). The fact that low acyl gellan gum stabilizes the foam layer, the most fragile constituent of the final triple layer system, ensures a robust shelf life for the foam layer; approximately four to six weeks under refrigeration, as indicated by informal stability testing.

The intermediate layer is an aerated gel layer which is a foam with a gelled network within it. This intermediate layer is quite creamy given the incorporated air, but does not contain any milk ingredients. The bottom layer is a fairly brittle dessert gel which contrasts with the upper two layers in terms of mouth-feel. Altogether the three layers are quite different and discernible in texture providing for a unique dessert experience when eaten layer by layer or when consumed in one cross-sectional serving.

One specific embodiment of the invention combines Kelcogel® or Kelcogel® F gellan gum and Myvatex™ Texture Lite K emulsifier blend to create a dessert gel with three distinct textures. This combination provides both the gelling and whipping agents in the current invention respectively. Optimal aeration for the solution occurs with high shear mixing (9000-10000 RPM) during cooling between the temperatures of 54° C. and 65° C. Shearing at temperatures above 65° C. will not integrate enough air into the liquid matrix while shearing below 54° C. runs the risk of shearing through the set point of Kelcogel® or Kelcogel® F gellan gum. The low viscosity of the Kelcogel® or Kelcogel® F gellan gum solution matrix allows for the rapid separation of the three layers, while the relatively high setting temperature of Kelcogel® or Kelcogel® F gellan gum stabilizes the triple layers, in particular stabilizing the very light foam layer. The unique physical properties of Kelcogel® or Kelcogel® F gellan gum combined with the aerating capabilities of Myvatex™ Texture Lite K emulsifier blend create a triple layer water gel based on a mechanism and process that is fundamentally different from the low setting temperature technology used in the production of the prior art systems.

### BRIEF DESCRIPTION OF THE FIGURES

FIG. 1: Figure one is a photograph of a triple layer self-separating dessert gel in aerated liquid form prior to separating and setting.

FIG. 2: Figure two is a photograph of a triple layer self-separating dessert gel after setting.

FIG. 3: Figure three is a photograph of a dual layer self-separating dessert gel in aerated liquid form prior to separating and setting.

FIG. 4: Figure four is a photograph of a dual layer self-separating dessert gel after setting.

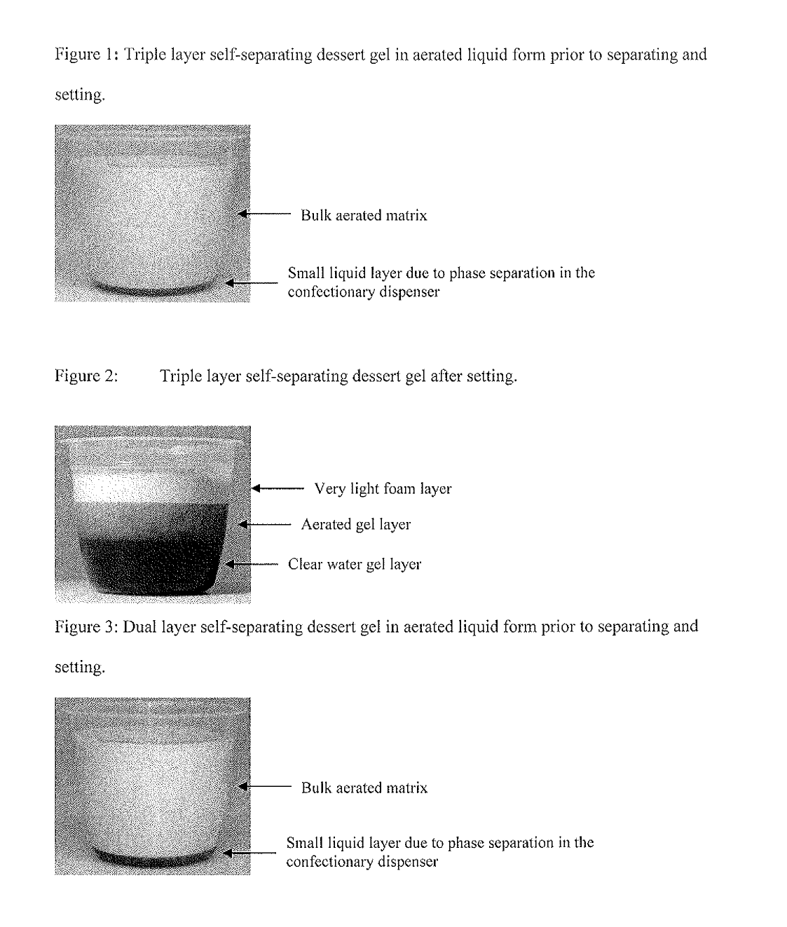

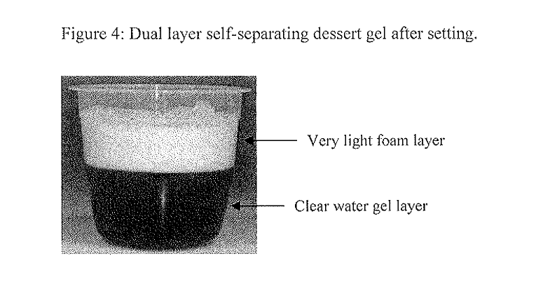

### DETAILED DESCRIPTION OF THE INVENTION

For purposes of this invention.

### Preferred Embodiments of the Invention

The following non-limiting examples provide teachings of various methods that are encompassed within this invention.

### EXAMPLE 1

TABLE 1
Ingredient list for triple layer self-separating dessert gel.

| Ingredients | Weight (g) | % (weight) |
|---|---|---|
| Water, tap | 825.90 | 82.59 |
| Sugar, fine granular | 150.00 | 15.00 |
| Emulsifier blend, Myvatex ™ Texture Lite K | 10.00 | 1.00 |
| (Kerry Bio-Science) | | |
| Citric acid, anhydrous | 5.00 | 0.50 |
| Sodium citrate dihydrate | 3.50 | 0.35 |
| Flavor | 3.00 | 0.30 |
| Kelcogel ® or Kelcogel ® F gellan gum | 2.00 | 0.20 |
| Sodium benzoate | 0.50 | 0.05 |
| Color | 0.10 | 0.01 |
| Total | 1000.00 | 100.00 |

The process for producing the triple layer self-separating dessert gel requires close attention to the temperature of processing as well as the form and duration of shearing to ensure optimum aeration of the matrix which facilitates the separation of the dessert gel system into layers upon cooling and setting. The laboratory scale process/procedure is as follows:
1. Dry blend sugar, Myvatex™ Texture Lite K emulsifier blend, citric acid, sodium citrate dihydrate, Kelcogel® or Kelcogel® F gellan gum, and sodium benzoate to physically disperse these ingredients to avoid lump formation upon addition to water.
2. Add the dry blend to the tap water while stirring with a propeller mixer to avoid lump formation.
3. Heat to 85 to 90° C. to hydrate the Kelcogel® or Kelcogel® F gellan gum.
4. Add flavor and color and stir until the emulsifier blend is melted uniformly.
5. Transfer solution (˜85° C.) to a warmed non-insulated stainless steel beaker. Ensure that solution temperature does not drop below 54° C. in transfer to prevent pre-gelation.
6. Begin shearing hot solution (˜85° C.) at highest available speed (9000-10000 RPM) using a very high shear mixer such as a Silverson mixer. Temperature will initially drop slightly and then will begin to rise with shearing. This initial shearing helps break down the particle size of the emulsifier powder, eliminating any grittiness in the final dessert gel.
7. When solution temperature begins to rise, place stainless steel beaker into cold water bath, to begin cooling process; continue mixing at maximum speed (9000-10000 RPM) in order to break down emulsifier particles and whip in air. The bulk of the aeration will occur when cooling from 65° C. to 54° C. To guarantee a triple layer dessert gel ensure that the amount of time the liquid matrix is exposed to high shear mixing is minimized (<1 minute) when cooling from 65° C. to 54° C. Ensure that solution temperature does not drop below 54° C.
8. Once temperature reaches 54° C., remove beaker from high shear mixer. The cooled solution will be considerably lighter in color due to aeration.
9. Quickly deposit solution into clear dessert cup using a confectionary depositor—during depositing continually mix the bulk matrix with a whisk in the depositor to prevent layer separation prior to depositing.
10. Let dessert cups sit at room temperature to allow solution to separate into three layers and set.
11. Seal dessert cups.
12. Refrigerate.
13. Shelf-life of refrigerated samples is approximately four to six weeks.

As seen in Table 1, one of the main ingredients required to make the triple layer self-separating dessert gel is Myvatex™ Texture Lite K emulsifier blend. This emulsifier blend is commercially available from Kerry Bio-science, www.kerrygroup.com.

### EXAMPLE 2

TABLE 2
Ingredient list for a dual layered dessert gel created by blending room
temperature Cool-Whip with a 60° C. solution of
Kelcogel ® or Kelcogel ® F gellan gum.

| | Dry Mix | | Need | % Wet |
|---|---|---|---|---|
| Ingredients | Weight | % Dry Mix | 1000 g | mix |
| Kelcogel ® or Kelcogel ® | 0.2000 | 0.25 | 2.40 | 0.25 |
| F gellan gum | | | | |
| Citric Acid | 0.5000 | 0.63 | 6.00 | 0.63 |
| Sodium Citrate | 0.4200 | 0.53 | 5.04 | 0.53 |
| Sugar | 15.0000 | 19.04 | 180.00 | 19.04 |
| Flavor | 0.1500 | 0.19 | 1.80 | 0.19 |
| Color | 0.0072 | 0.01 | 0.09 | 0.01 |
| Water | 62.5000 | 79.34 | 750.00 | 79.34 |
| Cool Whip at room | | | 4 cups | |
| temperature | | | | |
| Total Mass | 78.7772 | 100.0000 | 945.33 | 100.00 |

1. Dry blend Kelcogel ® or Kelcogel ® F gellan gum, sugar, citric acid and sodium citrate.
2. Add the dry blend to the water with shear in order to disperse the dry blend and avoid lump formation.
3. Heat to 85-90° C.
4. Add flavor, color; stir until blended/melted.
5. Let temperature of solution drop to ~60° C.
6. Add room temperature Cool Whip topping to solution by spoonfuls; continue stirring with propeller until Cool Whip is melted and mixture is blended - Maintain temperature at ~60° C.
7. Fill into cups and seal hot.
8. Transfer to refrigerator to complete setting.

### EXAMPLE 3

TABLE 3
Ingredient list for the foam portion of a two stage dual layer dessert gel.

| Ingredients | Weight (g) | % (weight) |
|---|---|---|
| Kelcogel ® or Kelcogel ® F gellan gum | 2.00 | 0.2000 |
| Citric Acid | 5.00 | 0.5000 |
| Sodium Citrate | 3.50 | 0.3500 |
| Sugar | 150.00 | 15.0000 |
| Flavor | 2.50 | 0.2500 |
| Color | 0.10 | 0.0100 |
| Water | 832.90 | 83.2900 |
| Myvatex ™ Texture Lite K | 4.00 | 0.4000 |
| Total Mass | 1000.00 | 100.0000 |

1. Dry blend Kelcogel ® or Kelcogel ® F gellan gum, sugar, citric acid, sodium citrate, and Myvatex ™ Texture Lite K.
2. Add the dry blend to the water with shear in order to disperse the dry blend and avoid lump formation.
3. Heat to 85-90° C.
4. Add flavor, color; stir until blended/melted.
5. Transfer to hobart bowl and whip until solution is aerated and toom temperature is reached.

TABLE 4
Ingredient list for the low acyl gellan gum solution for a two stage
dual layer dessert gel.

| Ingredients | Weight (g) | % weight |
|---|---|---|
| Kelcogel ® or Kelcogel ® F gellan gum | 2.00 | 0.20 |
| Citric Acid | 5.00 | 0.50 |
| Sodium Citrate | 3.50 | 0.35 |
| Sugar | 150.00 | 15.00 |
| Flavor | 2.50 | 0.25 |
| Color | 0.10 | 0.01 |
| Water | 836.90 | 83.69 |
| Total Mass | 1000.00 | 100.00 |

1. Dry blend Kelcogel ® or Kelcogel ® F gellan gum, citric acid, sodium citrate, and sugar.
2. Add the dry blend to the water with shear in order to disperse the dry blend and avoid lump formation.
3. Heat to 85-90° C.
4. Add flavor, color; stir until blended/melted.
5. Let solution cool to ~54° C.
6. Add whipped foam when temperature of the low acyl gellan solution reaches ~54° C.
7. Fill into pre-heated glass beakers and let sit on bench to set

### EXAMPLE 4

TABLE 5
Ingredient list for a triple layer self-separating dessert gel.

| Ingredients | Weight (g) | % (weight) |
|---|---|---|
| Kelcogel ® or Kelcogel ® F gellan gum | 2.00 | 0.20 |
| Citric Acid | 5.00 | 0.50 |
| Sodium Citrate | 3.50 | 0.35 |
| Sugar | 150.00 | 15.00 |
| Flavor | 2.50 | 0.25 |
| Color | 0.10 | 0.01 |
| Water | 826.90 | 82.69 |
| Myvatex ™ Texture Lite K | 10.00 | 1.00 |
| Total Mass | 1000.00 | 100.00 |

1. Dry blend Kelcogel ® or Kelcogel ® F gellan gum, citric acid, sodium citrate, sugar and Myvatex ™ Texture Lite K.
2. Add the dry blend to the water with shear in order to disperse the dry blend and avoid lump formation.
3. Heat to 85-90° C.
4. Add flavor, color; stir until blended/melted.
5. Mix hot solution at highest speed (9000-10000 RPM) using a laboratory scale Silverson mixer on a cold water bath to break down fat particles and whip in air; ensure temperature does not drop below 54° C. and solution does not over whip (<1 minute of cooling and mixing between 65° C. and 54° C.).
6. Fill into pre-heated glass beakers and let sit on bench to separate.
7. Transfer to refrigerator to complete setting.

### EXAMPLE 5

TABLE 6
Ingredient list for a triple-layered dessert gel with a short shelf-life
foam layer due to relatively low Myvatex ™ Texture Lite K level (0.6%).

| Ingredients | Weight (g) | % (weight) |
|---|---|---|
| Kelcogel ® or Kelcogel ® F gellan gum | 2.00 | 0.20 |
| Citric Acid | 5.00 | 0.50 |
| Sodium Citrate | 3.50 | 0.35 |
| Sugar | 170.00 | 17.00 |
| Flavor | 3.00 | 0.30 |
| Color | 0.10 | 0.01 |
| Water | 810.40 | 81.04 |
| Myvatex ™ Texture Lite K | 6.00 | 0.60 |
| Total Mass | 1000.00 | 100.00 |

1. Dry blend Kelcogel ® or Kelcogel ® F gellan gum, citric acid, sodium citrate, sugar and Myvatex ™ Texture Lite K.
2. Add the dry blend to the water with shear in order to disperse the dry blend and avoid lump formation.
3. Heat to 85-90° C.
4. Add flavor, color; stir until blended/melted.
5. Mix hot solution at highest speed (9000-10000 RPM) using a laboratory scale Silverson mixer on a cold water bath to break down fat particles and whip in air; ensure temperature does not drop below 54° C. and solution does not over whip (<1 minute of cooling and mixing between 65° C. and 54° C.).
6. Fill into pre-heated glass beakers and let sit on bench to separate.
7. Transfer to refrigerator to complete setting.

### EXAMPLE 6

TABLE 7
Ingredient list for a dual-layered dessert gel due increased shearing
time (two to three minutes) during cooling.

| Ingredients | Weight (g) | % (weight) |
|---|---|---|
| Kelcogel ® or Kelcogel ® F gellan gum | 2.00 | 0.20 |
| Citric Acid | 5.00 | 0.50 |
| Sodium Citrate | 3.50 | 0.35 |
| Sugar | 150.00 | 15.00 |
| Flavor | 3.00 | 0.30 |
| Color | 0.10 | 0.01 |
| Water | 826.40 | 82.64 |
| Myvatex ™ Texture Lite K | 10.00 | 1.00 |
| Total Mass | 1000.00 | 100.00 |

1. Dry blend Kelcogel ® or Kelcogel ® F gellan gum, citric acid, sodium citrate, sugar and Myvatex ™ Texture Lite K.
2. Add the dry blend to the water with shear in order to disperse the dry blend and avoid lump formation.
3. Heat to 85-90° C.
4. Add flavor, color; stir until blended/melted.
6. Mix hot solution at highest speed (9000-10000 RPM) using a laboratory scale Silverson mixer on a cold water bath to break down fat particles and whip in air; ensure temperature does not drop below 54° C., Cool and mix solution for two to three minutes between 65° C. and 54° C.
6. Fill into pre-heated glass beakers and let sit on bench to separate.
7. Transfer to refrigerator to complete setting.

### EXAMPLE 7

TABLE 8
Ingredient list for a triple layer self-separating dessert gel.

| Ingredients | Weight (g) | % (weight) |
|---|---|---|
| Kelcogel ® or Kelcogel ® F gellan gum | 2.00 | 0.20 |
| Citric Acid | 5.00 | 0.50 |
| Sodium Citrate | 3.50 | 0.35 |
| Sugar | 150.00 | 15.00 |
| Flavor | 3.00 | 0.30 |
| Color | 0.10 | 0.01 |
| Water | 826.40 | 82.64 |
| Myvatex ™ Texture Lite K | 10.00 | 1.00 |
| Total Mass | 1000.00 | 100.00 |

1. Dry blend Kelcogel ® or Kelcogel ® F gellan gum, citric acid, sodium citrate, sugar and Myvatex ™ Texture Lite K.
2. Add the dry blend to the water with shear in order to disperse the dry blend and avoid lump formation.
3. Heat to 85-90° C.
4. Add flavor, color; stir until blended/melted.
5. Mix hot solution at highest speed (9000-10000 RPM) using a laboratory scale Silverson mixer on cold water bath to break down fat particles and whip in air; ensure temperature does not drop below 54° C. and solution does not over whip (<1 minute of cooling and mixing between 65° C. and 54° C.).
6. Fill into pre-heated glass beakers and let sit on bench to separate.
7. Transfer to refrigerator to complete setting.

### EXAMPLE 8

TABLE 9
Ingredient list for a triple layer self-separating dessert gel where
a portion of the aerated mixture is removed prior to pouring.

| Ingredients | Weight (g) | % (weight) |
|---|---|---|
| Kelcogel ® or Kelcogel ® F gellan gum | 2.00 | 0.20 |
| Citric Acid | 5.00 | 0.50 |
| Sodium Citrate | 3.50 | 0.35 |
| Sodium Benzoate | 0.50 | 0.05 |
| Sugar | 150.00 | 15.00 |
| Myvatex ™ Texture Lite K | 10.00 | 1.00 |
| Tap Water | 825.90 | 82.59 |
| Flavor | 3.00 | 0.30 |
| Color | 0.10 | 0.01 |
| Total Mass | 1000.00 | 100.00 |

1. Dry blend Kelcogel ® or Kelcogel ® F gellan gum, citric acid, sodium citrate, sodium benzoate, sugar and Myvatex ™ Texture Lite K.
2. Add the dry blend to the water with shear in order to disperse the dry blend and avoid lump formation.
3. Heat to 85-90° C.
4. Add flavor, color; stir until blended/melted.
5. Transfer solution to uninsulated pitcher and move to Silverson mixer.
6. Mix hot solution at highest speed (9000-10000 RPM) until its temperature begins to rise.
7. Place pitcher on cold water bath and continue to mix with Silverson mixer at maximum speed (9000-10000 RPM) to break down fat particles and whip in air; ensure solution temperature does not drop below 54° C. and solution does not over whip (<1 minute of cooling and mixing between 65° C. and 54° C.).
8. Once temperature reaches ~54° C. remove pitcher from Silverson mixer.
9. Pour off ~250 mL of foam.
10. Pour remaining solution into plastic cups and let sit at room temperature on bench to separate and set.
11. Seal with cup sealer.
12. Transfer to refrigerator to complete setting.

### EXAMPLE 9

TABLE 10
Ingredient list for a dual layer self-separating dessert gel due
increased shearing time (two to three minutes), where a portion
of the aerated mixture is removed prior to pouring and
the remaining solution is poured in two consecutive pourings.

| Ingredients | Weight (g) | % (weight) |
|---|---|---|
| Kelcogel ® or Kelcogel ® F gellan gum | 2.00 | 0.20 |
| Citric Acid | 5.00 | 0.50 |
| Sodium Citrate | 3.50 | 0.35 |
| Sodium Benzoate | 0.50 | 0.05 |
| Sugar | 150.00 | 15.00 |
| Myvatex ™ Texture Lite K | 10.00 | 1.00 |
| Tap Water | 825.90 | 82.59 |
| Flavor | 3.00 | 0.30 |
| Color | 0.10 | 0.01 |
| Total Mass | 1000.00 | 100.00 |

1. Dry blend Kelcogel ® or Kelcogel ® F gellan gum, citric acid, sodium citrate, sodium benzoate, sugar and Myvatex ™ Texture Lite K.
2. Add the dry blend to the water with shear in order to disperse the dry blend and avoid lump formation.
3. Heat to 85-90° C.
4. Add flavor, color; stir until blended/melted.
5. Transfer solution to uninsulated pitcher and move to Silverson mixer.
6. Mix hot solution at highest speed (9000-10000 RPM) until its temperature begins to rise.
7. Place pitcher on cold water bath and continue to mix with Silverson mixer at highest speed (9000-10000 RPM) to break down fat particles and whip in air; ensure solution temperature does not drop below 54° C. Cool and mix solution for two to three minutes between 65° C. and 54° C.
8. Once temperature reaches ~54° C. remove pitcher from Silverson mixer.
9. Pour off ~400 mL of foam.
10. Immediately fill to halfway each of the clear dessert cups.
11. Top up each clear dessert cup with remaining mix
12. Let sit at room temperature on bench to separate and set.
13. Seal with cup sealer.
14. Transfer to refrigerator to complete setting.

### EXAMPLE 10

TABLE 11
Ingredient list for a triple layer self-separating dessert gel where
a portion of the aerated mixture is removed prior to pouring and
the remaining solution is poured in two consecutive pourings.

| Ingredients | Weight (g) | % (weight) |
|---|---|---|
| Kelcogel ® or Kelcogel ® F gellan gum | 2.00 | 0.20 |
| Citric Acid | 5.00 | 0.50 |
| Sodium Citrate | 3.50 | 0.35 |
| Sodium Benzoate | 0.50 | 0.05 |
| Sugar | 150.00 | 15.00 |
| Myvatex ™ Texture Lite K | 10.00 | 1.00 |
| Tap Water | 825.90 | 82.59 |
| Flavor | 3.00 | 0.30 |
| Color | 0.10 | 0.01 |
| Total Mass | 1000.00 | 100.00 |

1. Dry blend Kelcogel ® or Kelcogel ® F gellan gum, citric acid, sodium citrate, sodium benzoate, sugar and Myvatex ™ Texture Lite K.
2. Add the dry blend to the water with shear in order to disperse the dry blend and avoid lump formation.
3. Heat to 85-90° C.
4. Add flavor, color; stir until blended/melted.
5. Transfer solution to uninsulated pitcher and move to Silverson mixer.
6. Mix hot solution at highest speed (9000-10000 RPM) until its temperature begins to rise.
7. Place pitcher on cold water bath and continue to mix with Silverson mixer at highest speed (9000-10000 RPM) to break down fat particles and whip in air; ensure solution temperature does not drop below 54° C. and solution does not over whip (<1 minute of cooling and mixing between 65° C. and 54° C.).
8. Once temperature reaches ~54° C. remove pitcher from Silverson mixer.
9. Pour off ~400 mL of foam.
10. Immediately fill to halfway each of the clear dessert cups.
11. Top up each clear dessert cup with remaining mix.
12. Let sit at room temperature on bench to separate and set.
13. Seal with cup sealer.
14. Transfer to refrigerator to complete setting.

### EXAMPLE 11

TABLE 12
Ingredient list for a triple layer self-separating dessert gel (experimental
process upon which Table 1 is based).

| Ingredients | Weight (g) | % (weight) |
|---|---|---|
| Kelcogel ® or Kelcogel ® F gellan gum | 2.00 | 0.20 |
| Citric Acid | 5.00 | 0.50 |
| Sodium Citrate | 3.50 | 0.35 |
| Sodium Benzoate | 0.50 | 0.05 |
| Sugar | 150.00 | 15.00 |
| Myvatex ™ Texture Lite K | 10.00 | 1.00 |
| Tap Water | 825.90 | 82.59 |
| Flavor | 3.00 | 0.30 |
| Color | 0.10 | 0.01 |
| Total Mass | 1000.00 | 100.00 |

1. Dry blend Kelcogel ® or Kelcogel ® F gellan gum, citric acid, sodium citrate, sodium benzoate, sugar and Myvatex ™ Texture Lite K.
2. Add the dry blend to the water with shear in order to disperse the dry blend and avoid lump formation.
3. Heat to 85-90° C.
4. Add flavor, color; stir until blended/melted.
5. Transfer solution to uninsulated pitcher and move to Silverson mixer.
6. Mix hot solution at highest speed (9000-10000 RPM) until its temperature begins to rise.
7. Place pitcher on cold water bath and continue mix with Silverson mixer at maximum speed (9000-10000 RPM) to break down fat particles and whip in air; ensure temperature does not drop below 54° C. and solution does not over whip (<1 minute of cooling and mixing between 65° C. and 54° C.).
8. Once temperature reaches ~54° C. remove pitcher from Silverson mixer.
9. Transfer to warmed confectionery depositor and continually mix solution.
10. Deposit into clear dessert cups.
11. Let sit at room temperature on bench to separate and set.
12. Seal with cup sealer.
13. Transfer to refrigerator to complete setting.

1. A food composition comprising a first layer, a second layer and a third layer, wherein said food composition comprises:
a. water;
b. low acyl gellan gum; and
c. an emulsifier.

2. A food composition of claim 1 wherein said emulsifier comprises monoglycerides, propylene glycol monoester, sodium stearoyl lactylate, calcium silicate, or a combination thereof.

3. A food composition of claim 1 comprising an emulsifier in an amount between about 0.01% (w/w) and 5% (w/w).

4. A food composition of claim 3 comprising about 1% (w/w) of an emulsifier.

5. A food composition of claim 1 comprising low acyl gellan gum in an amount between about 0.01% (w/w) and 2% (w/w).

6. A food composition of claim 5 comprising about 0.2% (w/w) of low acyl gellan gum.

7. A food composition of claim 1 further comprising a flavorant, a colorant, a sweetener, a preservative, a buffer system or a combination thereof.

8. A food composition comprising a first layer and a second layer wherein said first layer and said second layer comprise:
a. water;
b. low acyl gellan gum; and
c. an emulsifier comprising at least one of a monoglyceride, propylene glycol monoester, sodium stearoyl lactylate, calcium silicate, or a combination thereof.

9. A food composition of claim 8 comprising an emulsifier in an amount between about 0.01% (w/w) and 5% (w/w).

10. A food composition of claim 9 comprising about 1% (w/w) of an emulsifier.

11. A food composition of claim 8 comprising low acyl gellan gum in an amount between about 0.01% (w/w) and 2% (w/w).

12. A food composition of claim 11 comprising about 0.2% (w/w) of low acyl gellan gum.

13. A food composition of claim 8 further comprising a flavorant, a colorant, a sweetener, a preservative, a buffer system or a combination thereof.

14. A food composition comprising at least a first layer and a second layer, wherein said food composition comprises:
a. water;
b. low acyl gellan gum; and
c. an emulsifier,
wherein said second layer is an aerated layer and wherein said second layer does not require a protein to achieve stability.

15. A food composition of claim 14 wherein said second layer is a mousse.

16. A food composition of claim 14 wherein said emulsifier comprises monoglycerides, propylene glycol monoester, sodium stearoyl lactylate, calcium silicate, or a combination thereof.

17. A food composition of claim 14 comprising an emulsifier in an amount between about 0.001% (w/w) and 5% (w/w).

18. A food composition of claim 17 comprising about 1% (w/w) of an emulsifier.

19. A food composition of claim 14 comprising low acyl gellan gum in an amount between about 0.01% (w/w) and 2% (w/w).

20. A food composition of claim 19 comprising about 0.2% (w/w) of low acyl gellan gum.

21. A food composition of claim 14 further comprising a flavorant, a colorant, a sweetener, a preservative, a buffer system or a combination thereof.

22. A process of preparing a multi-layered food composition comprising the steps of:
i. dry blending the low acyl gellan gum and the emulsifier to form a dry blend;
ii. adding the dry blend of step (i) to water to form a mixture;
iii. agitating the mixture of step (ii);
iv. heating the mixture of step (iii) to a temperature above about 54° C.;
v. subjecting the mixture of step (iv) to high shear mixing at a temperature above about 54° C.;
vi. cooling the mixture of step (v) to about 54° C. while continuing to mix said mixture; and
vii. ceasing the mixing of the mixture of step (vi),
wherein said food composition comprises water, low acyl gellan gum and an emulsifier.

23. A process of claim 22 wherein steps (ii) and (iii) occur concurrently.

24. A process of claim 22 wherein steps (ii) and (iii) overlap.

25. A process of claim 22 wherein steps (ii), (iii) and (iv) occur concurrently.

26. A process of claim 22 wherein steps (ii), (iii) and (iv) overlap.
